(19) United States
(12) Patent Application Publication
(10) Pub. No.: US 2018/0020386 A1
(43) Pub. Date: Jan. 18, 2018

(54) IMPROVEMENTS IN HANDOVERS BETWEEN DIFFERENT ACCESS NETWORKS

(71) Applicant: NOKIA SOLUTIONS AND NETWORKS OY, Espoo (FI)

(72) Inventors: Devaki CHANDRAMOULI, Plano, TX (US); Subramanya CHANDRASHEKAR, Bangalore (IN); Hans Thomas HOEHNE, Helsinki (FI); Cinzia SARTORI, Pullach (DE); Woonhee HWANG, Espoo (FI)

(21) Appl. No.: 15/547,268

(22) PCT Filed: Jan. 30, 2015
(86) PCT No.: PCT/US2015/013756

§ 371 Date: Jul. 28, 2017

(51) Int. Cl. H04W 36/14; H04W 36/32; H04W 36/00

(52) U.S. Cl. CPC H04W 36/14; H04W 36/0027; H04W 36/32

(57) ABSTRACT

Methods and devices for improvements in handover between different access networks which enable seamless services to be experienced by a terminal. An aspect encompasses a device, comprising a processor configured to provide control in a control plane for a terminal for access to a first access network and to a second access network, wherein a coverage of the second access network at least partly overlaps the coverage of the first access network, the terminal is capable of having access to the first access network with a first service and to the second access network with a second service in parallel, and access for the terminal to a respective access network is routed in a user plane via a respective distinct access network entity.

### FIELD OF THE INVENTION

The present invention relates to improvements in handovers between different access networks. In particular, it relates to arrangements providing improvements in terms of service continuity during handovers between different access networks.

### BACKGROUND

Mobile data transmission and data services are constantly making progress. With the increasing penetration of such services, different access networks may coexist in parallel. Typically, in relation to mobile communication systems, an access network is represented by a radio access network (RAN) which is based on a certain radio access technology (RAT). While “radio” is a typical medium for mobile communication, other media are intended to be also covered by the principles taught herein. For example, Infrared or Bluetooth® or other media and/or wavelengths of radio are possible to represent the medium deployed for the access network. As there has to be a (backward) compatibility between newly developed and pre-existing access networks and/or access network technologies, terminals often have a capability to communicate based on one or more access networks technologies. Also, when a new access network is developed and launched, the network is not immediately available in the entire country of deployment, but its coverage may be limited to certain areas and be successively expanded over time.

The present invention will herein below be explained with reference to LTE as one example of a first access network or radio access technology (LTE is also known as fourth generation (4G) mobile communication) and its successor or improvement which is currently being developed and referred to as 5G (fifth generation) mobile communication as a second access network or radio access technology. Though, principles set out herein below are applicable to other scenarios of first and second access networks, too. Typically, a mobile communication network consists of an access network establishing the physical transport of data (payload (user) data and control data) and a core network establishing the control functionality for the entire network and the interoperability of the network with other networks, e.g. via gateways. References to specific network entities or nodes and their names are intended as mere example only. Other network node names may apply in different scenarios while still accomplishing the same functionality. Also, the same functionality may be moved to another network entity. Therefore, the principles as taught herein below are not to be understood as being limited to the specific scenario referred to for explanation purposes.

For example, EPS is the Evolved Packet System, and the successor of GPRS (General Packet Radio System). It provides a new radio interface and new packet core network functions for broadband wireless data access. Such EPS core network functions are the Mobility Management Entity (MME), Packet Data Network Gateway (PDN-GW also referred to as P-GW) and Serving Gateway (S-GW).

FIG. 1 illustrates the Evolved Packet Core architecture as introduced and defined by 3GPP TS 23.401 v13.1.0.

The entities involved and interfaces between them are defined in that document and reference is made thereto for further details. Acronyms used in the Figure are listed at the end of this specification. A common packet domain core network is used for both Radio Access Networks (RAN), the GERAN and the UTRAN. This common core network provides GPRS services.

E-UTRAN, the evolved UTRAN, represents the nowadays known 4G network. Its successor referred to as 5G network is under development.

It is envisioned that such 5G system will provide new mobile low-latency and ultra-reliable services, and some services like V2X will be more efficiently provided by 5G system.

A reference to a possible 5G architecture that is envisioned is depicted in FIG. 2, which represents the present inventors' internal working assumption for a future 5G architecture.

The entities involved and interfaces there between are for example denoted by the acronyms as used in the Figure which are listed at the end of this specification.

In brief, a terminal such as a 5G NT (network terminal or user equipment UE) is provided with an internet protocol IP user network interface, IP UNI, and an Ethernet user network interface, ETH UNI, and may communicate via a Uu* interface with an access point AP in the mobile access network. The entire network has a mobile access part and a networking service part and an application part. Within each of those parts, there exists a control plane (interfaces in the control plane being denoted by suffix “c”) and a user (data) plane (interfaces in the user plane being denoted by suffix “u”). The AP is located in both planes. Application plane related interface are denoted by suffix “a”, while an interface between the cMGW and the uGW is labeled as Sx. The interface between the cSE and the uSE is not denoted with a specific label.

During the early days of 5G deployment, it is expected that the 5G coverage area is not nationwide. It is therefore desirable that a solution is developed to allow 5G devices to camp in other radio access technologies (e.g. LTE) that are widely available so that a terminal or user equipment UE does not lose the connection to the network immediately after losing 5G coverage.

FIG. 3 shows such an example scenario in a simplified manner. A terminal 1, such as a user equipment UE, e.g. exemplified by a so-called smartphone or another portable communication device, may move due to its mobility from a position A to a position B. In position A, it experiences the coverage of a LTE (4G) network as a first access network as well as of a 5G network as a second access network. The coverage of a respective network is graphically illustrated by a respective hatching. The 5G network is represented by an access point AP denoted by 2. The 4G network is represented in this example by 3 eNB's (or three 4G access points) denoted by 3a, 3b, 3c, respectively. The 4G network has a greater coverage as compared to the coverage of the 5G network. The coverage of both networks overlaps at least partly as illustrated and denoted by the arrow labeled “4+5G”.

As shown, when moving from A to B, the terminal leaves the 4+5G coverage and enters the 4G only coverage, which may imply problems.

For a terminal UE exiting the 5G area (Mobility):

There is a need for a solution for fast re-establishment or re-allocation of services to other radio technologies in case the UE runs out of 5G coverage (i.e. handover due to radio link loss).

For UE entering the 5G area (Mobility):

There is a need for a solution for fast establishment or allocation of services to 5G to provide better quality of service to UE.

In order to achieve seamless mobility from the user perspective, there is a need for a mobility solution that offers some or all of the following objectives:
Improved reliability
Minimized service disruption
Enables the user to retain all services during iRAT handover.

The traditional iRAT handover between 4G and 5G systems is similar to the iRAT HO between 3G and 4G. It is a hard handover which involves setting up the control plane connections and subsequently setting up the services in the new RAT after getting them terminated in the source RAT.

The noticeable part of such procedure is the absence of seamless service continuity while moving from one RAT (source RAT) to another RAT (destination RAT). There is also signaling connection re-establishment, which adds to the service disruption time during handover.

Thus, there is still a need to further improve such systems in terms of handovers between different radio access networks, i.e. iRAT HO's.

### SUMMARY

Various aspects of examples of the invention are set out in the claims.

According to a first aspect of the present invention, there is provided a device comprising a processor configured to provide control in a control plane for a terminal for access to a first access network and to a second access network, wherein a coverage of the second access network at least partly overlaps the coverage of the first access network, the terminal is capable of having access to the first access network with a first service and to the second access network with a second service in parallel, and access for the terminal to a respective access network is routed in a user plane via a respective distinct access network entity, wherein the processor is configured to receive a message indicative of the availability of the second access network, determine, based on the message received, whether the second service via the second access network for the terminal can be provided via the second access network, and to initiate, based on the determination, a modification of the routing in a user plane for the second service via the second access network.

Note that as a result of such teaching being applied, the second service will be routed through the first access network.

Advantageous further developments of such device are as set out in respective dependent claims.

According to a second aspect of the present invention, there is provided a method comprising providing control in a control plane for a terminal for access to a first access network and to a second access network, wherein a coverage of the second access network at least partly overlaps the coverage of the first access network, the terminal is capable of having access to the first access network with a first service and to the second access network with a second service in parallel, and routing access for the terminal to a respective access network in a user plane via a respective distinct access network entity, wherein the method comprises receiving a message indicative of the availability of the second access network, determining, based on the message received, whether the second service via the second access network for the terminal can be provided via the second access network, and initiating, based on the determination, modifying of the routing in a user plane for the second service via the second access network.

Note that as a result of such teaching being applied, the second service will be routed through the first access network.

Advantageous further developments of such method are as set out in respective dependent claims.

According to a third aspect of the present invention, there is provided a computer program product comprising computer-executable components which, when the program is run on a computer, are configured to perform the method according to any one of the above mentioned method aspects including its further developments.

The above computer program product may further comprise computer-executable components which, when the program is run on a computer, perform the method aspects mentioned above in connection with the method aspects.

The above computer program product/products may be embodied as a computer-readable storage medium.

Thus, performance improvement in relation to iRAT HOs is based on those methods, devices and computer program products.

For example, while some solution options which may be considered to offer Inter RAT HO between 4G and 5G relate to a traditional interworking architecture (assuming a single connectivity only) or a traditional Interworking architecture with dedicated core (assuming a dual connectivity option), those are not exploited in relation to the present invention and its aspects.

Rather, the principles as presented in relation to at least one or more aspects of the present invention start from an interworking architecture with a common core (dual connectivity option—common NAS context) and/or from an interworking architecture with common core and multi controller (dual connectivity option—common AS context, common NAS context).

According to at least an aspect of the solution presented herein, user plane service continuity can be provided when there is an inter RAT handover between 4G and 5G, i.e. from 5G to 4G. Further, such service continuity is provided without re-establishment of signaling connections. The solution thus offers in at least aspects thereof a seamless handover of services.

For instance, briefly stated, if the user by means of his user equipment or terminal has a service flow to obtain internet services in 5G and the user loses (or is about to lose) radio link connection in 5G (by going out of 5G coverage), then in order to offer seamless user experience, there is proposed a solution to offer internet services in 4G either before or immediately after loss of radio link is detected.

Detection of radio link failure can be accomplished by radio link measurements on the networks side or terminal side. Also, a failure may be predicted prior to its actual occurrence based on consecutive measurements. In such case, due to deterioration or fading away of radio link quality, radio link failure may be anticipated or predicted. In general, radio link failure happens when the SINR (signal to interference noise ratio) is too low for a period of time (or drops by more than a certain amount, or drops below a certain threshold, or a combination thereof), which can happen because of too high interference or too low signal strength. A “fading away” of the link could be understood to include both effects.

### BRIEF DESCRIPTION OF DRAWINGS

For a more complete understanding of example embodiments of the present invention, reference is now made to the following descriptions taken in connection with the accompanying drawings in which:

FIG. 1 illustrates a commonly known architecture of the EPS;

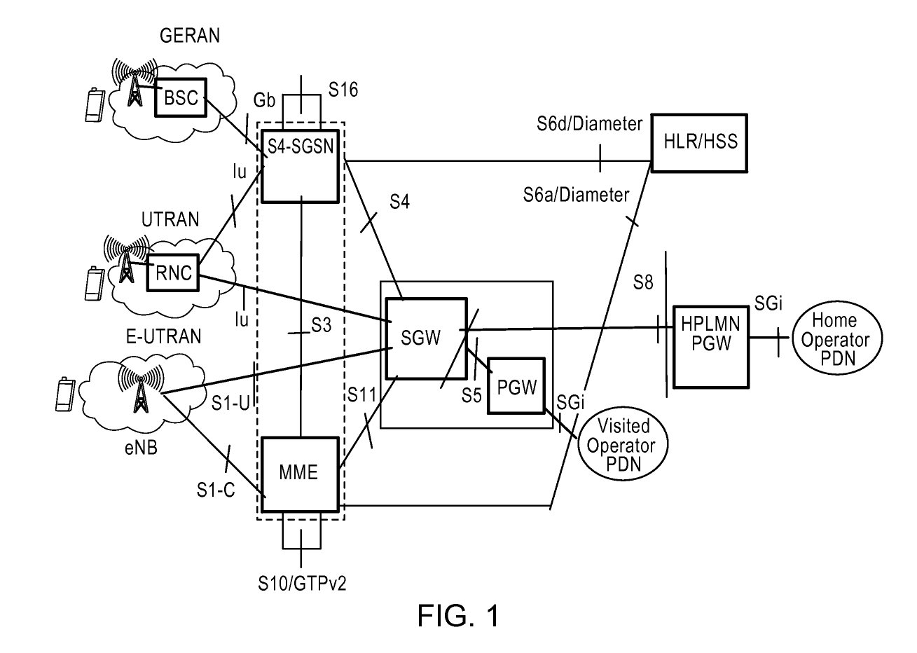

FIG. 2 illustrates a possible reference architecture of a 5G network;

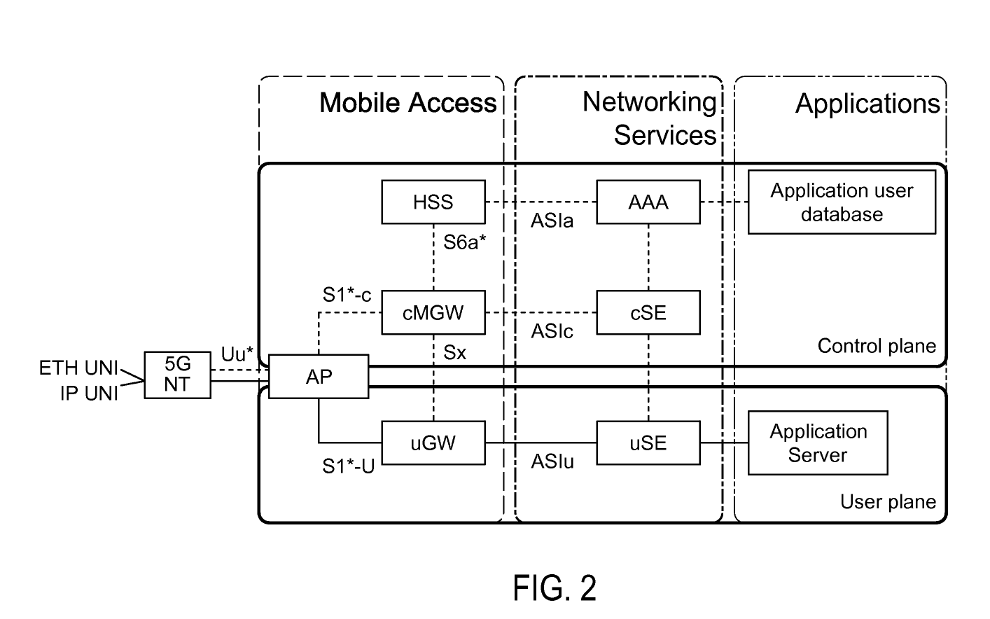

FIG. 3 illustrates a iRAT HO scenario to which the present invention can be advantageously applied;

FIG. 4 illustrates a first example embodiment of the invention;

FIG. 5 illustrates a second example embodiment of the invention;

FIG. 6 illustrates a third example embodiment of the invention;

FIG. 7 illustrates a fourth example embodiment of the invention;

### DESCRIPTION OF EXEMPLARY EMBODIMENTS

Exemplary aspects of the invention will be described herein below.

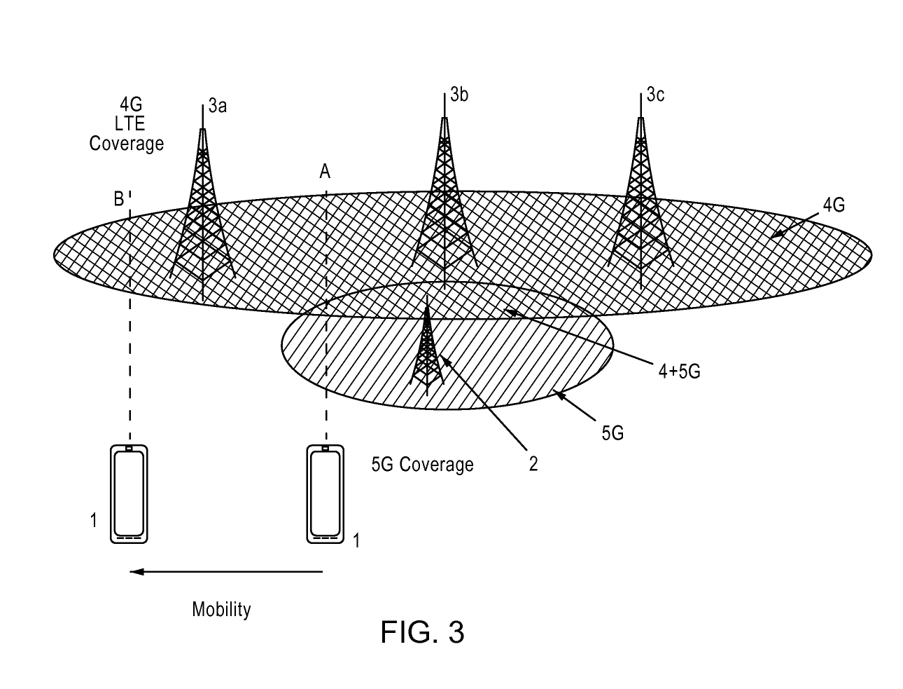

Generally, the invention is implemented in a scenario as illustrated in FIG. 3 in terms of an inter RAT handover, iRAT HO.

In this scenario, it is subsequently assumed that the terminal UE is 4G and 5G capable (has dual connectivity), i.e. the terminal (UE) is capable to have access to a first access network (4G) and to a second access network (5G). The terminal UE has a RRC connection (i.e. in the control plane) in the first access network, 4G, and in the second access network, 5G, simultaneously and/or in parallel. (That is, the RRC connections may coexist in time, but may be established and/or released at different times.) The terminal UE is assumed to be served by a common core network (i.e. a control plane GW and a user plane GW) that is common for the first and second access networks, and thus supports 4G and 5G networks. Also, as shown in FIG. 3, the coverage of the second access network (5G) at least partly overlaps the coverage of the first access network (4G), and the terminal is capable of having access to the first access network with a first service (S1) and to the second access network with a second service (S2) in parallel. Access for the terminal to a respective access network (4G, 5G) is routed in a user plane via a respective distinct access network entity (via eNB for 4G, via 5GAP for 5G).

In such scenario, for example, according to at least some aspects of the invention, there is proposed a device comprising a processor which is configured to receive a message indicative of the availability of the second access network, determine, based on the message received, whether the second service (S2) via the second access network (5G) for the terminal can be provided via the second access network and to initiate, based on the determination, a modification of the routing in a user plane for the second service via the second access network.

According to individual further aspects,
the message indicative of the availability of the second access network (5G) is received from the access network entity (5GAP) of the second access network.
the message indicative of the availability of the second access network is indicative of a failure of the access to the second access network;
the message indicative of the availability of the second access network is indicative of a predicted failure of the access to the second access network;
the message indicative of a predicted failure of the access to the second access network is derived by and received from the access network entity of the second access network based on a measurement report from the terminal to that access network entity;
the message indicative of a predicted failure of the access to the second access network is derived by and received from the terminal based on measurements of the terminal;
the processor is further configured to evaluate, based on service requirements for the second service, whether the second service can be provided via the first access network, and initiate the modification of the routing for the second service dependent on the evaluation;
the processor is configured to initiate the modification of the routing in the user plane for the second service via the second access network such that the user plane for the second service is established (and/or combined) with the user plane for the first service in the first access network;
the processor is configured to modify the routing in the user plane for the second service by mapping the second service, identified by a service flow identifier, to the user plane in the first access network;
the processor is configured to map the second service, identified by the service flow identifier, to the user plane of the first access network, by means of one of an access bearer relocation procedure, an access bearer setup procedure, a default bearer activation procedure.

Stated in other words, solutions presented herein are applicable to at least the following scenarios:

Scenario 1:

Proactive scenario (“Make iRAT HO before break (of connection)”)
a. Establish the (2^{nd}) service in LTE (1^{st} access network) when 2^{nd} access network detects that radio link quality is deteriorating. (network initiated)
b. UE detects that it is in the border of (2^{nd} network) 5G coverage area thus requests for a new service setup in LTE before radio link breaks in 5G (UE/terminal initiated)

Scenario 2:

Reactive scenario (“Break (of connection) before making iRAT HO”)
a. Establish the (2^{nd}) service in LTE (1^{st} access network) after radio link drops in 5G (2^{nd} access network). (network initiated)
b. UE detects that it has lost 5G coverage thus requests for a new service setup in LTE after radio link breaks in 5G (UE initiated)

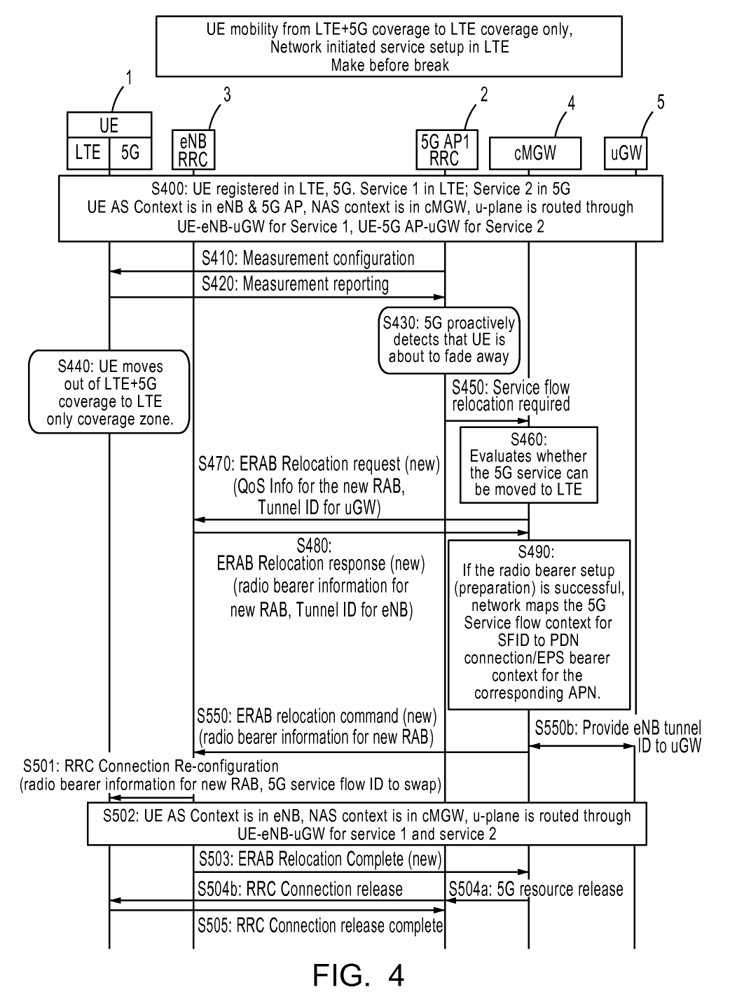

Details of those scenarios are exemplified in the signaling diagrams illustrated in FIGS. 4 to 7, representing example embodiments 1 to 4, respectively. For all those Figures, it is noted that entities involved are illustrated in the horizontal arrangement as well as the signaling messages exchanged there between. Actions performed by individual entities are illustrated in the respective boxes, wherein the vertical arrangement of the boxes and signaling messages basically and/or schematically represents the timing thereof in relation to the other actions/signaling.

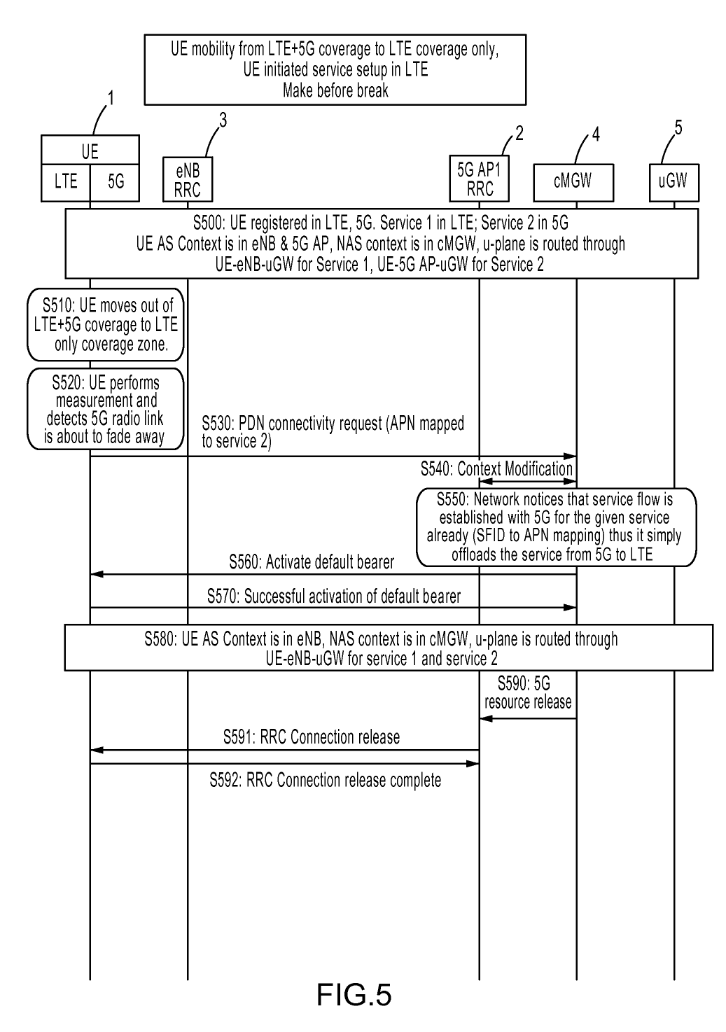

Entities involved are basically a terminal UE denoted by 1, capable of communication in 4G and 5G, i.e. in a first and a second access network. A eNB/RRC of the first access network is denoted by 3. A 5G AP/RRC of the second access network is denoted by 2. A cMGW is denoted by 4 and a uGW is denoted by 5. This applies to FIGS. 4 to 7. In FIGS. 5 & 6, there is also illustrated a S/P-GW denoted by 6.

As shown in all FIGS. 4 to 7, and as assumed for all scenarios illustrated/explained here, the terminal UE denoted by 1 is registered in a first access network such as LTE for service 1, and in a second access network such as 5G for service 2. The UE is served by a common core network (cMGW and uGW) which is common to the first (4G) and second (5G) access network. The UE is moving out of LTE+5G coverage to LTE coverage only (as also illustrated in/explained with reference to FIG. 3). These assumptions and/or starting scenario are illustrated in stages or steps labeled S400, S500, S600, S700 in FIGS. 4 TO 7, RESPECTIVELY.

### EXAMPLE EMBODIMENT 1/FIG. 4

Example embodiment 1 is illustrated in FIG. 4 and pertains to the above “scenario la”, i.e. establishing the service in LTE when network detects that radio link quality (in 5G) is deteriorating (approach is network initiated).

It is to be understood that this involves a proactive establishment of radio access bearers in the LTE network for the service supported in 5G when there is radio link failure in 5G, and that this enables seamless user experience for service 2. Advantageously, there is no signaling connection re-establishment or hard handover in this inter RAT handover scenario.

Stated in other words, for this and other scenarios, a processor of the cMGW is configured to receive a message indicative of the availability of the second access network, determine, based on the message received, whether the service (S2) via the second access network (5G) for the terminal can be provided via the second access network, and to initiate, based on the determination, a modification of the routing in a user plane for the second service via the second access network. That is, the processor is configured to, responsive to the determination that the second service (S2) via the second access network (5G) for the terminal can no longer be provided via the second access network, initiate the modification of the routing in the user plane for the second service via the second access network such that the user plane for the second service is combined with the user plane for the first service in the first access network. This implies in some example scenario that the processor is configured to modify the routing in the user plane for the second service by mapping the second service, identified by a service flow identifier, to the user plane in the first access network.

Referring to FIG. 4 in more detail, a starting scenario is illustrated in stage S400. When the UE 1 is in both, LTE and 5G coverage, it is proposed that the (5G) network (e.g. 5GAP denoted by 2) configures the UE 1 for measurements for both 5G and LTE. See stage/step S410. The terminal UE denoted by 1 reports in a stage S420 measurements to the 5GAP denoted by 2. Based on that the 5GAP denoted by 2 proactively detects (stage S430) that the UE 1 is about to fade away, i.e. to lose 5G coverage. (See stage S440: UE moves out of LTE+5G coverage to LTE only coverage). 5GAP 2 can then report (stage S450) towards the common core network, i.e. cMGW denoted by 4 that the service flow relocation is required to LTE. The cMGW denoted by 4 evaluates (stage S460) whether the 5G service can be established in (or “moved to”) LTE. Based on that, (i.e. if “yes”) cMGW initiates (cf. stages S470 and the following) a ERAB relocation procedure that starts with a ERAB relocation request (stage S470) in LTE. (If “not” (not shown in this Figure), service 2 may be suspended or terminated or service requirements/parameters may be renegotiated/adapted.) It provides the necessary QoS information for the new RAB, such as tunnel ID for the uGW to enable bearer setup (stage S550b). When the radio bearer establishment within the network is successful (stage S490), the network notifies (stages S550/S550b/S501) the UE that the service 2 has now been setup in LTE. After the UE successfully acknowledges the bearer establishment (S503), the network releases (S504a, S504b, S505) the resources allocated for service 2 in 5G. This method helps to enable seamless user experience when there is loss of radio link in one access technology and the other access technology is available.

Thus, as shown in FIG. 4 in stage S502, (and in FIGS. 5 to 7 in corresponding stages S580, S690, and S780, respectively), responsive to the determination that the second service (S2) via the second access network (5G) for the terminal can no longer be provided via the second access network, there is initiated the modification of the routing in the user plane for the second service via the second access network such that the user plane for the second service is combined with the user plane for the first service in the first access network.

### EXAMPLE EMBODIMENT 2/FIG. 5

Example embodiment 2 is illustrated in FIG. 5 and pertains to the above “Scenario 1b” in which the terminal UE detects that it is in the border of 5G coverage area and thus requests for a new service setup (for service S2) in LTE (in the first access network) before radio link breaks in the second access network, e.g. 5G (approach is UE initiated).

A starting scenario is represented by stage S500. When the terminal UE denoted by numeral 1 is in both, LTE and 5G coverage, it is proposed that the UE 1 performs measurements of both access networks, 5G and LTE (4G) network. The terminal UE denoted by 1 moves out of 5G+LTE coverage to LTE only coverage, as indicated by stage S510. When the UE 1 based on its own measurements, see state S520, detects that the 5G radio link is about to fade away (e.g. based on a threshold based decision, such as a SINR or other measurement value is below a threshold value, or drops by a certain value), it initiates (cf. stage S530) a PDN connectivity request for service 2 in LTE network in association with a context modification (stage S540). The cMGW notices, see stage S550, that a service flow is established with 5G for the same service e.g. based on a service flow ID and/or APN mapping and thus it simply offloads the service 2 from 5G to LTE (thus optimizing resource allocation). The offloading encompasses activation of a default bearer, stages S560, S570, and subsequent resource release in the second access network, stages S590, and RRC connection release, S591, S592.

In particular, in the course of and as a result of this procedure, as shown in stage S580, there is a modification of the routing in the user plane for the second service via the second access network such that the user plane for the second service is combined with the user plane for the first service in the first access network.

Also this method as shown in FIG. 5 enables a seamless user experience when there is loss of radio link in one access technology and the other access technology is available.

Thus, based on the request from UE to establish a PDN connection for service 2, the network determines that the same service is already established in 5G. Thus, it is proposed to offload the service from 5G to LTE in order to optimize use of network resources and at the same time offer seamless user experience. It is to be noted that there is no signaling connection re-establishment or hard handover also in this inter RAT handover scenario.

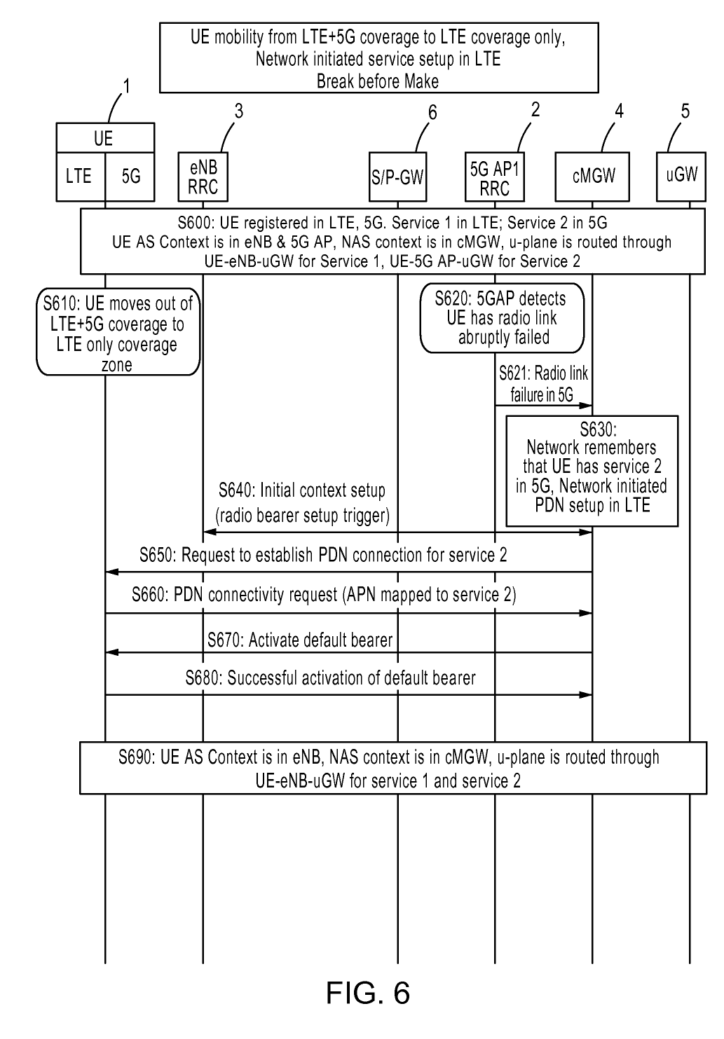

### EXAMPLE EMBODIMENT 3/FIG. 6

Example embodiment 3 is illustrated in FIG. 6 and pertains to the above “scenario 2a”, i.e. to establish the service in LTE after the radio link drops in 5G (this approach is network initiated).

It is not always possible to ensure a “make before break”, i.e. still without a radio link failure. To cope with such scenarios, in which a radio link fails and could not be predicted to fail (cf. stage S610: UE leaves 5G+LTE coverage to LTE coverage only), the 5GAP denoted by 2 is configured to detect (stage S620) and report (stage S621) the radio link failure to the common core network (e.g. the cMGW entity). Since the cMGW is aware (stage S630) of the circumstances that the terminal UE 1 has service 2 in 5G, it initiates a PDN connectivity setup in LTE network in order to establish service 2 in LTE. That is, stages S640 through S680 perform a modification of the routing in the user plane for the second service (provided via the second access network) such that the user plane for the second service is combined with the user plane for the first service in the first access network, as shown in the resulting stage S690.

As derivable from the detailed signaling flow in FIG. 6, according to the example embodiment 3, a network initiated PDN connection setup in LTE network is performed for a service that was offered in different RAT, i.e. 5G in this case. This is based on and/or triggered by a radio link failure detection in the second access network, e.g. 5GAP. It is to be noted also here that there is no core network relocation, and no signaling connection re-establishment in this inter RAT handover scenario. This—like in other example embodiments—ensures that the service disruption is minimized, even though it is a case of “break before make” scenario.

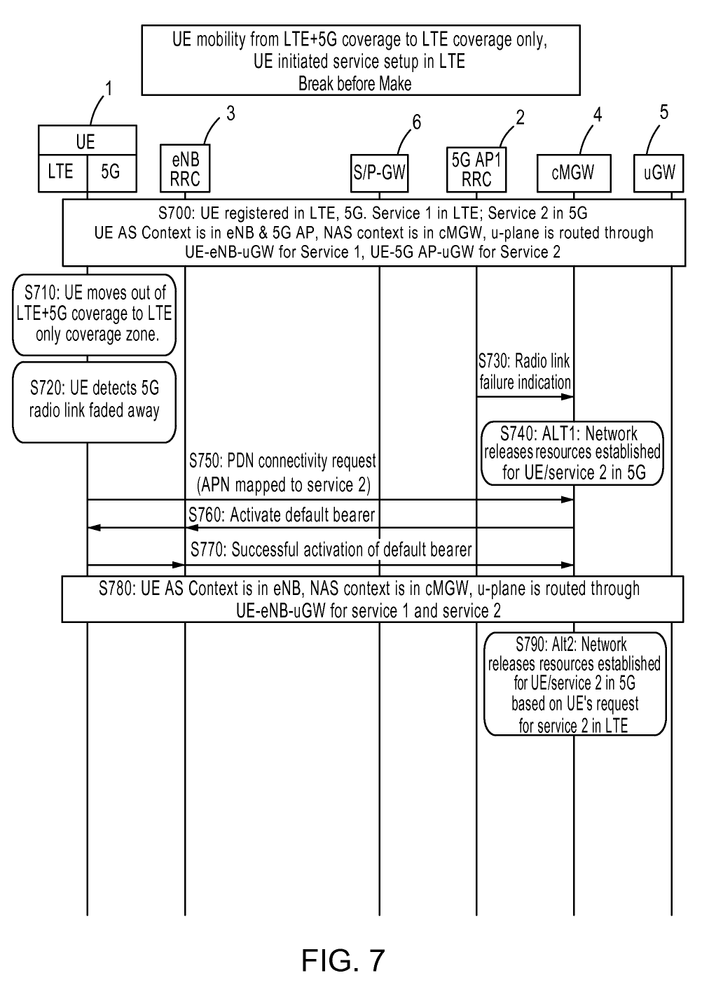

### EXAMPLE EMBODIMENT 4/FIG. 7

Example embodiment 4 is illustrated in FIG. 7 and pertains to the above Scenario 2b, i.e. to establish the second service in the first access network, i.e. LTE/4G after the radio link drops in the second access network, i.e. 5G (this approach is UE initiated).

Here it is again assumed that the terminal UE 1 moves out of the LTE+5G coverage to LTE only coverage (cf. stage S710) and detects (cf. stage S720) the radio link failure. Triggered by the detection in stage S720, the terminal UE 1 initiates, in this example scenario at least, a PDN connectivity procedure (stages S750 through S770) to establish the second service in the first access network, i.e. LTE.

According to an alternative, at (about) the same time at which the terminal UE detects the 5G raio link failure, the 5G_AP denoted by numeral 2 may have also detected that the UE has lost the radio link to the second access network and thus reports this to the cMGW denoted by 4.

In this case, cMGW 4 releases resources (stage S740) based on/responsive to the 5GAP's notification (in a stage S730) that the radio link has failed. Alternatively, the entity cMGW denoted by numeral 4 releases the resources established for the UE/service 2 in 5G based on the UE's request for the same service in LTE, i.e. responsive to the signaling illustrated in stages S750 through S770. The resources are then released as shown in stage S790.

Thus, also according to embodiment 4, the network entity such as the cMGW denoted by numeral 4, performs a modification of the routing in the user plane for the second service (provided via the second access network) such that the user plane for the second service is combined with the user plane for the first service in the first access network

As derivable from FIG. 7, according to the illustrated aspect of example embodiment 4, the entity cMGW has the ability to release the resources established for UE in relation to a service (S2) in 5G when the UE requests to establish the same service in LTE. It is to be noted that also according to this example embodiment there is no core network relocation, no signaling connection re-establishment in this inter RAT handover scenario. This ensures that the service disruption is minimized, even though it is a case of “break before make” scenario.

It is noted that not only as shown in stage S460 of the first example embodiment, but also as a modification (not shown) to all further example embodiments 2 to 4 as described herein above, the device cMGW of the second network, i.e. the processor thereof is optionally further configured to evaluate, based on service requirements for the second service (and in conjunction with capabilities of the first access network), whether the second service can be provided via the first access network, and to initiate the modification of the routing for the second service dependent on the evaluation.

That is, the second service is rerouted to the access network of the first network if the first network can provide such service, too. If not, the second service may be terminated or at least suspended for the terminal. The suspension/termination may be signaled from the device cMGW to the terminal. Also, the service requirements as represented by service parameters (typically one or more of quality of service QoS parameters) may also be adapted to fit to the first, i.e. 4G network or be re-negotiated between the first and second (access) network so that the second service can be provided via the first network.

More generally, it has to be noted that also the method, devices and computer program products presented herein are generally applicable to any type of inter RAT HOs which shall benefit from seamless services. A variety of other systems can benefit also from the principles presented herein as long as they have identical or similar properties. For example, the different access networks shall advantageously share a common core network, e.g. a user plane gateway uGW which supports both access networks. Further, a terminal experiencing handover shall preferably be a dual connectivity terminal having a connection/services in both (first and second) access networks upon leaving one (the second) access network. The principles are not restricted to be applied to radio networks but other (wireless) media may also be possible as at least one of the first and second access networks between which a terminal may experience mobility.

Herein above, a focus was laid on describing aspects of the invention in relation to a device (such as a cMGW) which comprises a processor configured to provide control in a control plane for a terminal (UE) for access to a first access network (4G) and to a second access network (5G), wherein a coverage of the second access network (5G) at least partly overlaps the coverage of the first access network (4G), the terminal is capable of having access to the first access network with a first service (S1) and to the second access network with a second service (S2) in parallel, and access for the terminal to a respective access network (4G, 5G) is routed in a user plane via a respective distinct access network entity (eNB, 5GAP), wherein the processor is configured to receive a message indicative of the availability of the second access network, determine, based on the message received, whether the service (S2) via the second access network (5G) for the terminal can be provided via the second access network, and to initiate, based on the determination, a modification of the routing in a user plane for the second service via the second access network.

It is to be understood that such principles are likewise applicable to and that the aspects of the invention can be realized by a corresponding method. For example, such method is represented in at least an aspect by a method comprising providing control in a control plane for a terminal (1) for access to a first access network (4G) and to a second access network (5G), wherein a coverage of the second access network (5G) at least partly overlaps the coverage of the first access network (4G), the terminal is capable of having access to the first access network with a first service and to the second access network with a second service in parallel, and routing access for the terminal to a respective access network (4G, 5G) in a user plane via a respective distinct access network entity (3, 2), wherein the method comprises receiving a message indicative of the availability of the second access network, determining, based on the message received, whether the second service via the second access network (5G) for the terminal can be provided via the second access network, and initiating, based on the determination, modifying of the routing in a user plane for the second service via the second access network.

Embodiments of the present invention may be implemented in software, hardware, application logic or a combination of software, hardware and application logic.

The software, application logic and/or hardware each generally resides on a network entity such as a cMGW or similar functional entity.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under CDMA, WCDMA, FDMA, LTE/4G, 5G, WIMAX and WLAN or others and can advantageously be implemented in user equipments or smart phones, or personal computers connectable to such networks. That is, it can be implemented as/in chipsets to connected devices, and/or modems thereof. More generally, all such products which are correspondingly configured in line with at least one or more of the aspects of the invention will experience improvements in iRAT HOs with the invention being implemented thereto.

While scenarios were distinguished between network initiated or terminal initiated, it is to be understood that both scenarios can coexist for use and that depending on specific conditions a selection there between can be made and/or preference can be given by configuration to either a user initiated or network initiated procedure. Also switching between those configurations is possible based on appropriate specific conditions.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The present invention proposes methods and devices for improvements in handover between different access networks which enable seamless services to be experienced by a terminal. An aspect encompasses a device (4), comprising a processor configured to provide control in a control plane for a terminal (1) for access to a first access network (4G) and to a second access network (5G), wherein a coverage of the second access network (5G) at least partly overlaps the coverage of the first access network (4G), the terminal is capable of having access to the first access network with a first service and to the second access network with a second service in parallel, and access for the terminal to a respective access network (4G, 5G) is routed in a user plane via a respective distinct access network entity (3, 2), wherein the processor is configured to receive a message indicative of the availability of the second access network, determine, based on the message received, whether the second service via the second access network (5G) for the terminal can be provided via the second access network, and to initiate, based on the determination, a modification of the routing in a user plane for the second service via the second access network. Also, corresponding methods and computer program products are encompassed.

### List of Acronyms/Abbreviations as Used Herein

| | |
|---|---|
| AAA | Authentication, Authorization and Accounting |
| AP | access point |
| APN | Access Point Name |
| AS | access stratum |
| ASIx | application service instance/interface x |
| BSC | base station controller (2G) |
| cMGW | control plane Mobile Gateway (5G) |
| CN | core network |
| c-plane | control plane |
| CS | circuit switched |
| cSE | control-plane service edge |
| DC | Dual Connectivity |
| DIAMETER | protocol name, succesor of RADIUS |
| EDGE | enhanced data rates for GSM evolution |
| eNB | evolved Node_B (4G) |
| EPS | Evolved Packet System |
| ERAB | EPS Radio Access Bearer |
| ETH UNI | Ethernet User Network Interface |
| GERAN | GSM/EDGE Radio Access Network |
| GSM | Global System for Mobile Communications |
| GTP | GPRS Tunneling Protocol |
| GPRS | General Packet Radio Service (2G) |
| GW | gateway |
| HLR | home location register (2G) |
| HO | Handover |
| HPLMN | Home Public Land Mobile Network |
| HSS | home subscription server/home subscriber server |
| IP UNI | Internet Protocol User Network Interface |
| iRAT | inter RAT |
| LTE | Long Term Evolution (4G) |
| P-GW | see PDN-GW |
| PDN-GW | packet data network GW (3G, 4G) |
| RADIUS | remote authentication dial in user service |
| MME | mobility management entity (4G) |
| NAS | Non-Access Stratum |
| NT | network terminal |
| RAN | radio access network |
| RAT | radio access technology |
| RNC | radio network controller (3G) |
| RRC | radio resource control (3G, 4G, 5G) |
| S-GW | serving gateway (3G, 4G) |
| SGSN | Serving Gateway Support Node |
| SINR | signal to interference noise ratio |
| UE | User Equipment |
| uGW | user-plane GW |
| uSE | user-plane service edge |
| UTRAN | universal terrestrial radio access network |
| e-UTRAN | evolved UTRAN |
| V2X | vehicular to any |

1. A device, comprising:
a processor configured to provide control in a control plane for a terminal for access to a first access network and to a second access network, wherein
a coverage of the second access network at least partly overlaps the coverage of the first access network,
the terminal is capable of having access to the first access network with a first service and to the second access network with a second service in parallel, and
access for the terminal to a respective access network is routed in a user plane via a respective distinct access network entity,
wherein
the processor is configured to
receive a message indicative of the availability of the second access network,
determine, based on the message received, whether the second service-via the second access network for the terminal can be provided via the second access network, and to
initiate, based on the determination, a modification of the routing in a user plane for the second service via the second access network.

2. The device according to claim 1, wherein
the message indicative of the availability of the second access network is received from the access network entity of the second access network.

3. The device according to claim 1, wherein
the message indicative of the availability of the second access network is indicative of a failure of the terminal access to the second access network.

4. The device according to claim 1, wherein
the message indicative of the availability of the second access network is indicative of a predicted failure of the terminal access to the second access network.

5. The device according to claim 4, wherein
the message indicative of a predicted failure of the terminal access to the second access network is derived by and received from the access network entity of the second access network based on a measurement report from the terminal to that access network entity.

6. The device according to claim 4, wherein
the message indicative of a predicted failure of the terminal access to the second access network is derived by and received from the terminal based on measurements of the terminal.

7. The device according to claim 1, wherein
the processor is further configured to
evaluate, based on service requirements for the second service, whether the second service can be provided via the first access network, and
initiate the modification of the routing for the second service dependent on the evaluation.

8. A device according to claim 1, wherein
the processor is configured to,
initiate the modification of the routing in the user plane for the second service via the second access network such that
the user plane for the second service is established with the user plane for the first service in the first access network.

9. A device according to claim 1, wherein
the processor is configured to
modify the routing in the user plane for the second service by mapping the second service, identified by a service flow identifier, to the user plane in the first access network.

10. A device according to claim 9, wherein
the processor is configured to
map the second service, identified by the service flow identifier, to the user plane of the first access network, by means of one of an access bearer relocation procedure, an access bearer setup procedure, a default bearer activation procedure.

11. A method, comprising:
providing control in a control plane for a terminal for access to a first access network and to a second access network, wherein a coverage of the second access network at least partly overlaps the coverage of the first access network, the terminal is capable of having access to the first access network with a first service and to the second access network with a second service in parallel, and routing access for the terminal to a respective access network in a user plane via a respective distinct access network entity,
wherein the method comprises
receiving a message indicative of the availability of the second access network,
determining, based on the message received, whether the second service via the second access network for the terminal can be provided via the second access network, and
initiating, based on the determination, modifying of the routing in a user plane for the second service via the second access network.

12. The method according to claim 11, comprising:
receiving the message indicative of the availability of the second access network from the access network entity of the second access network.

13. The method according to claim 11, wherein
the message indicative of the availability of the second access network is indicative of a failure of the access to the second access network.

14. The method according to claim 11, wherein
the message indicative of the availability of the second access network is indicative of a predicted failure of the access to the second access network.

15. The method according to claim 14, comprising:
receiving the message indicative of a predicted failure of the access to the second access network derived by the access network entity of the second access network based on a measurement report from the terminal to that access network entity.

16. The method according to claim 14, comprising:
receiving the message indicative of a predicted failure of the access to the second access network derived by the terminal based on measurements of the terminal.

17. The method according to claim 11, further comprising:
evaluating, based on service requirements for the second service, whether the second service can be provided via the first access network, and
initiating the modification of the routing for the second service dependent on the evaluation.

18. The method according to claim 11, further comprising:
initiating the modification of the routing in the user plane for the second service via the second access network such that
the user plane for the second service is established with the user plane for the first service in the first access network.

19. The method according to claim 11, further comprising:
modifying the routing in the user plane for the second service by mapping the second service, identified by a service flow identifier, to the user plane in the first access network.

20. (canceled)

21. A computer program product, embodied on a non-transitory computer-readable medium, said computer program product comprising computer-executable components which, when the program is run on a computer, are configured to perform the method according to claim 11.
